(19) United States
(12) Patent Application Publication
(10) Pub. No.: US 2007/0068284 A1
(43) Pub. Date: Mar. 29, 2007

(54) Airborne sampler array

(76) Inventors: Alonso Castro, Santa Fe, NM (US); Ricky C. Lopez, Espanola, NM (US); Murray E. Moore, Los Alamos, NM (US); Kathryn L. Creek, Los Alamos, NM (US); Perry C. Gray, Los Alamos, NM (US)

Correspondence Address: UNITED STATES DEPARTMENT OF ENERGY, 1000 INDEPENDENCE AVENUE, S.W., ATTN: GC-62 (ALO), MS 6F-067, WASHINGTON, DC, 20585-0162, US

(21) Appl. No.: 11/239,451

(22) Filed: Sep. 26, 2005

(51) Int. Cl. G01N 1/22

(52) U.S. Cl. 73/863.21

(57) ABSTRACT

A method and device for collecting airborne particulate samples comprising vacuum air intake tube(s) onto the distal end of each of which is connected a regulating nozzle that is covered by the well reservoir of a capture vessel. Ambient air is directed to impact the interior surfaces of a single or multi-reservoir capture vessel. Each such well reservoir may include additional collector media and can be fitted with a filter screen. A plurality of said intake tubes may also be assembled and automated for programmable sample times and duration through a manifold in order to service a standard well tray which provides for higher collection efficiencies. In situ pathogen detection is possible by inclusion of nucleic acid specific dyes or probes in the media and/or by attachment of an excitation light, radiation detector, or fluorometer device(s) focused on the internal surfaces of a semi-translucent well reservoir.

### STATEMENT REGARDING FEDERAL RIGHTS

This invention was made with Government support under Contract No. W-7405-ENG-36 awarded by the U.S. Department of Energy. The Government has certain rights in the invention.

### FIELD OF THE INVENTION

The present invention relates generally to a device and method used for the collection of airborne particulate samples using impaction and/or filtration in an assembly such that the nozzle heads are configured to coincide with the reservoirs of a capture vessel for programmable interval times/duration and easy transfer of the samples for laboratory analysis. The sampling device can be adapted for use remotely where it is desired to conduct a variety of sample analyses on site or in real time.

### BACKGROUND OF THE INVENTION

The collection of airborne particulate samples across the country for subsequent laboratory analysis is in need of automation. Very few sampling devices are available that can collect multiple samples. Short duration samplers are almost non-existent that would collect multiple samples in time sequence. Those that are available either have problems with use in an indoor public setting (due to air changes/rapid movement, high heat/humidity output, or the large volume of space), do not take many more than eight samples, or are very expensive. Attempts to mechanize collection and store the samples, such as presented in U.S. Pat. No. 6,138,521, have met with limited success. Almost all air sampling devices use a media to collect particulates or vapor either on a solid surface, foam, sorbent, or through filters. A sampling device of the prior art known to incorporate filtration screens and restrictor plates, such as presented In U.S. Pat. No. 6,779,411, directs particle exposure to a localized area concentrated on the collector medium. Each of these commercially available devices requires extensive sample handling of the media for subsequent analysis—taking time, costing money and involving a high risk of sample cross-contamination. The present sampler uses an impaction configuration which maximizes the area of impaction thereby allowing for higher volumes and higher collection efficiencies.

The subject sampling device can be used to collect air samples in many public assembly areas such as airports, courthouses, and other settings for monitoring biological aerosols for security applications. In addition, this sampler can be used in conjunction with a nucleic acid dye or probe to develop a rapid detection technique for bioaerosols to be potentially used for biological threat surveillance. This instrument could also be deployed in buildings to diagnose “sick building syndrome”, legionellosis, etc. or monitor for other infectious conditions. More broadly, this type of device could find applications in a host of commercial applications including feed lots, poultry houses, stadiums and/or closed manufacturing facilities of various kinds in order to continuously monitor indoor air quality. Although other airborne pathogen detectors are currently available, such as disclosed by U.S. Pat. No. 6,514,721, herein a multi-reservoir capture vessel need not be changed out for each new air sample.

Additional objects, advantages and novel features will be set forth in part in the description which follows, and in part will become apparent to those skilled in the art upon examination of the following or may be learned by practice of the invention. The objects and advantages of the invention may be realized and attained by means and instrumentalities and combinations particularly pointed out in the appended claims.

### SUMMARY OF THE INVENTION

A method and device for taking air samples is disclosed. The air sampler of the present invention has relatively few moving parts since it impacts particulates directly into a capture vessel through directional changes of air at a speed established by the sampling method. This sampler device is capable of taking multiple consecutive samples using impaction upon a multi-reservoir capture vessel that is extensively used in laboratory analysis. The method and device described allows limited sample handling thereby reducing the potential for sample contamination and sample loss thereby accuracy and sensitivity. The impaction design optionally removes the need for additional collection media thereby increasing detection limits for some particulates and reducing both the sample time intervals and amount of extraction needed for subsequent analysis.

### BRIEF DESCRIPTION OF THE DRAWINGS

The accompanying drawings, which are incorporated in and form a part of the specification, illustrate the embodiment(s) of the present invention and, together with the description, serve to explain the principles of the invention. In the drawings:

FIG. 1 shows a cross section of the nozzle head and intake tube.

FIG. 2 provides an isometric view of the same nozzle head and intake tube shown in FIG. 1.

FIG. 3 illustrates a detail view of the nozzle head and air flow circulation inside the capture vessel.

FIG. 4 is an isometric view of a flared nozzle array and well tray.

FIG. 5 represents a cross sectional view of a sampler array assembly.

### DETAILED DESCRIPTION

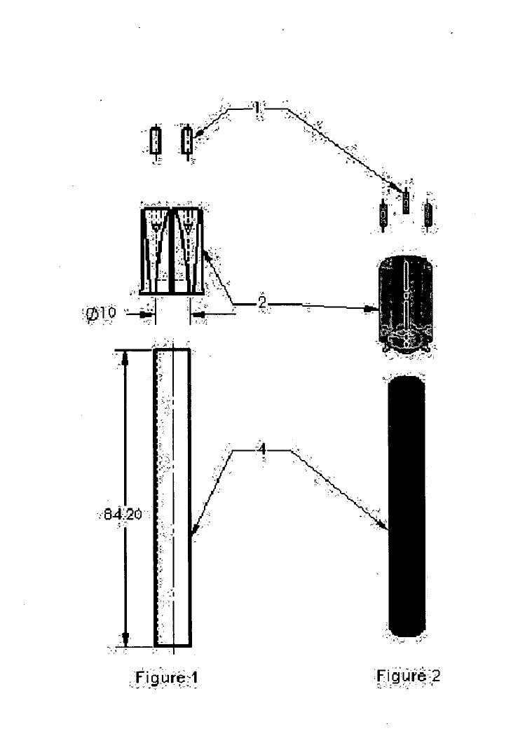

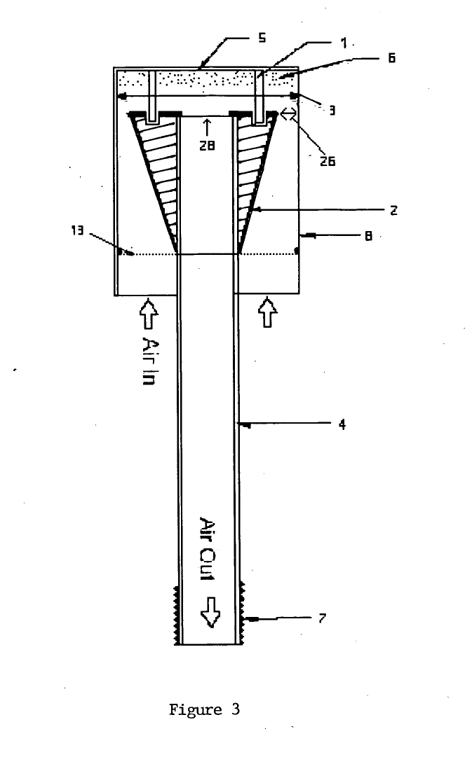

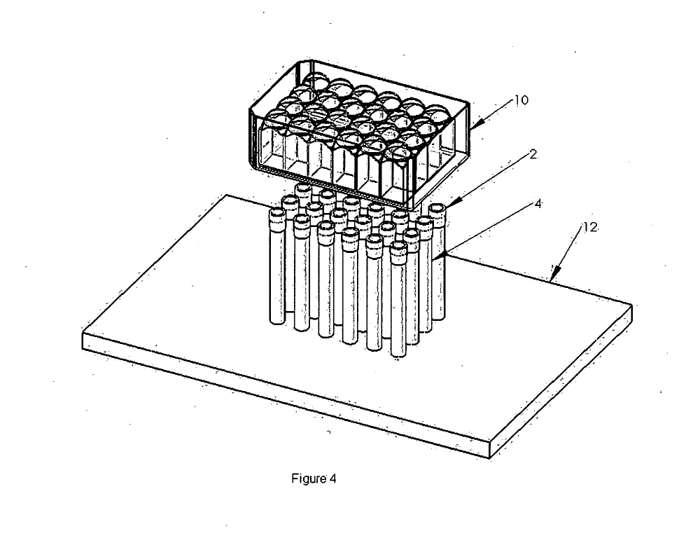

The airborne sampling device of the present invention employs a nozzle head and impaction format that forces particulate matter onto the internal surfaces a well tray reservoir or other capture vessel for automated analysis. This sampling device shown in it's simplest embodiment in FIGS. 1 and 2, comprises an intake tube 4 onto one end of which is attached a regulating nozzle head 2. The dimensions shown in FIG. 1 are relative and are provided for representation purposes only. Interstitial legs 1 which are inserted into the regulating nozzle 2, as shown in FIG. 3, can be used for mounting the capture vessel 8 spaced above the head as can other means of attachment. The distal end of such air intake tube 4 is fitted with a connection 7 via flexible transfer lines (not shown) to a vacuum pump or other means for the introduction of negative air pressure. The cross sectional view of FIG. 1 indicates recessed indentations in the nozzle head for the acceptance of the interstitial legs 1 which may be used to detachably affix the capture vessel 8. As shown in FIG. 3, the capture vessel functions best when the nozzle head 2 profile shape directs particulates onto the internal surfaces of the well reservoir 3 of such inverted vessel 8. Particulate impaction is increased when the vessel 8 is made from a material such as polystyrene that has an intrinsic or enhanced surface which is capable of embedding entrained airborne matter. Impaction efficiency may also be increased by optionally attaching additional collector media 6 such as foam, silicone spray, gel or other sorbent materials to the internal surfaces of the reservoir of the capture vessel 8. The shape of the nozzle head 2 may be a tapered, truncated conical, flared or fluted in design with a flat or domed face, each of which may possess central circular openings 28 or slits of predetermined width in order to regulate the air flow and achieve optimized capture parameters.

As shown by the air flow directional arrows in FIG. 3, ambient air is induced by negative pressurization into the capture vessel 8 where the, (inverted) truncated conical in this example, shape of the nozzle head 2 causes entrained particulate matter to accelerate and impact the walls and cap 5 of the well reservoir 3 before it is drawn through the nozzle head 2 opening into the intake tube 4. Airborne particles will be deposited on the vessel surface if the air speed is high enough so that when the direction of air flow is drastically changed by the contour of the nozzle head 2, the particles will not follow the path of the air stream, but impact upon the internal surfaces of the well reservoir 3. The particle size collected is dependent upon the air speed established by selection of the nozzle head 2 opening 28 and adjustment of the gap width 26—the latter “gap” being the distance separating the nozzle head 2 from the internal surfaces of the capture vessel 8.

The primary collection method, if additional media is not used, for this sampler array is inertial impaction, sedimentation and interception which will collect particle sizes of approximately 0.5 micrometer and above. For particles less than 0.5 micrometers, additional collection media, such as a porous foam, further discussed below, can be used to supplement the torturous path of the air flow and will collect such particles by diffusion. Additional collector media such as foam can also be used to collect organic vapors permitting subsequent chemical analysis. Again, the subject sampler is capable of accepting various vessel/media combinations which when joined with an optimized air flow rate will allow the capture of airborne particle size(s) and/or suspected air contaminants of interest.

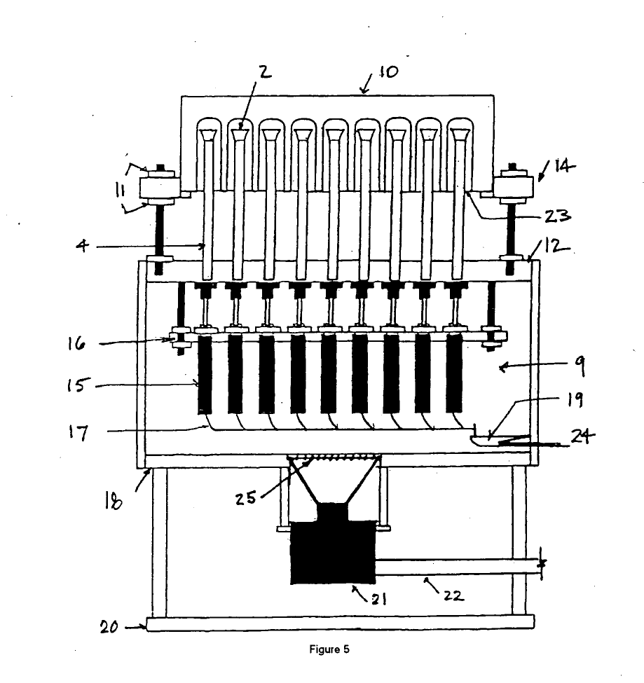

In another embodiment as shown in FIG. 4, the sampler device is characterized by the joining of a plurality of intake tubes matched with a coincident number of wells in the multi-reservoir capture vessel. This array is configured to accept a standard well tray 10 which is routinely used in the industry to conduct laboratory analyses. Each intake tube 4 in the array is fitted at one end with a, flared in this case, nozzle head 2 and is connected at their distal end with a connection to a tube array plate 12 for the purpose of stationary alignment. As seen in FIG. 5, a manifold assembly 18, which distributes negative air pressure, contains a number of valves 15 that typically coincide with number of nozzle heads 2 and wells of the multi-reservoir capture vessel 10, permitting sampling at one well location at a time. Interval sampling and duration times are established by these valves 15, which may be of a solenoid or other type, that are individually actuated by means of a wiring harness 17 connection to a printed circuit board 19 for control by a program on the circuit board and/or by two-way communication with a (not shown) remote computer system 24. Wireless computer 24 communication with the circuit board 19 is also possible and isolated sampler device operation can be conducted using a DC battery, generator, rechargeable unit other portable power source.

The manifold assembly 18 is contained in a pneumatically sealed plenum 9 spaced below the well plate 14 providing a gap 26 for ambient air to enter alongside the exterior of the sampler intake tube 4, underneath the well tray 10 and through the nozzle head 2 when activated. The well plate 14 has a central cutout which contains a shelf that is configured to the perimeter of the inverted well tray 10 which is penetrated by the plurality of intake tubes 4 for open communication with ambient air. The negative air pressure needed for activation is created by a variable speed vacuum pump or blower 21 that is in communication with the manifold chamber 9. An extraction pump of the size required to operate the sampler device shown in FIG. 5 for instance, will provide variable speeds of around 200 Liters of air per minute. The vacuum pump or blower 21 provides a negative air pressure differential to the manifold plenum 9 which alternatively acts through each valve 15 assembled on the valve array plate 16 to draw ambient air through the, fluted in this example, nozzle head 2 opening at preselected rates so as to deposit airborne particulates onto the interior surfaces of the well tray 10. A diffusion register 25 may be placed atop the vacuum pump 21 inlet for dissipating the pressurized air throughout the manifold plenum 9. The base plate 20 provides room in this embodiment for the pump 21 to be exhausted 22 externally. The circuit board 19 and/or remote computer 24 system control is programmed to set and/or change the air flow rate in the plenum chamber 9 via the variable speed vacuum pump or blower 21. In the FIG. 5 array, the well tray 10 detachably sits upon a well plate 14 platform that provides a vertical adjustment 11 capacity. The described configurations, which are capable of adjusting, via pieces 1 and 11, the distance separating the nozzle head 2 from the cap 5 of the capture vessel 8 and/or well tray 10, along with nozzle head 2 profile selection, allows for optimizing the air flow rate and deposition surface area, thereby permitting direct particulate impaction upon the capture vessel and eliminating or minimizing the need for any additional collector media.

It is well known that bacteria particle size vary from 1 to 5 microns and that pollen particle size varies from 10 to 20 microns, while virus particle size may be on the order of 0.3 microns or less. Hence, it may be advantageous, when sampling is focused upon measuring for the concentration of smaller size particles, to include a filtration screen 23, with or without the additional collector media 6. As shown in FIG. 3, such filters 13 may have a hole(s) cut in their center for placement either individually around the intake tube 4 inside the well reservoir 3 or as a filtration screen 23 sheet configured to be placed on top of the inverted well tray shown in FIG. 5. The mesh size of such filters can be chosen at 10 micron matrix, for instance, and can function to screen larger particles from the air sample collected. Given sufficient sample duration time however, these filters may become occluded with the larger air particles and tend to obstruct the orifice passageway. Accordingly, when filtration is to be employed, it may also be necessary to include a centrally located anemometer, rotameter or velocimeter type device (not shown) inside the manifold plenum 9. The latter air speed monitor device is electrically connected to the circuit panel 19 and serves to adjust the speed control of the vacuum pump 21 so as to compensate for any air flow pressure drop occasioned by inclusion of the filter screen 23.

Additional media 6 such as a silicone spray, polyurethane or porous foam, gel or other sorbent, or mixture thereof, may optionally be deposited in the well reservoir 3 of the capture vessel in order to enhance particulate collection. Media such as a foam material may also include growth or inhibitor agents or nucleic acid specific dyes or probes which may be radioactive or fluoresce in the presence of certain pathogens and are detectable by use of an attached fluorometer. Other biological materials and microorganisms naturally fluoresce or may be are detected using ultraviolet light, chemical extraction, or other biotriggers. Chemical elements are also capable of being captured and radioactive particulates can be sensed using radiation detectors dependent on the isotope(s) of interest. Should the subject sampler be focused upon detection of certain agents or pathogens which exhibit these characteristics, an excitation light source such as UV light and/or a fluorometer (not shown) incorporating photo-detectors, a dosimeter or similar sensing devices may be attached to the individual intake tube 4 of FIG. 3 or mounted to the tube array plate 12 of FIG. 4 and focused for scanning through a semi-translucent reservoir well onto the internal surfaces of the capture vessel. However, unlike WV light, several such sensing devices are not capable of encompassing the entirety of a multi-reservoir capture vessel 10 at once and need their movement automated to correlate with the air sampling sequence being taken. When employed, such sensing devices can be electrically connected through the circuit board 19 for relay to the remote computer 24 and/or system controlling building alerts. Pathogen detection methods utilizing enzymes, PCR, primers, cell lysing or other techniques may be utilized with the subject sampler during subsequent laboratory analysis.

It should be recognized that the sampler array presented in FIG. 5 is particularly well suited for gathering background data on the normal concentration levels of spores, pollen, fungi, grain matter, organic fragments, dust and other particulate constituents of air which is needed to distinguish between elevated levels and/or entrained pathogens. It should also be understood that modifications of the sampler described hereinabove are envisioned. For example, should several of the impaction head device(s) of FIG. 3 be separately placed at different locations throughout a building space, one could connect each sensor sampling port via flexible tubing to a central manifold plenum 9. Such plenum would have the well plate 14 and multi-reservoir capture vessel 10 assembly, indicated in FIG. 5, removed with the flexible air pressure lines connected to each intake tube 4 penetration. Another embodiment could involve having a single intake tube 4 and nozzle head 2 assembly, as shown in FIG. 3, automated so as to sequentially serve the various stations of a multi-reservoir capture vessel 10. Yet another embodiment would involve having several intake tubes 4 collecting samples simultaneously at several stations of a multi-reservoir capture vessel 10 which sequence may be matched to a ganged head sensing device assembly. Variations in the shape of the nozzle head 2 and to the means used to detect certain airborne pathogens are also possible as diagnostic techniques are developed and the state of the art advances.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various modifications as are suited to the particular use contemplated. It is intended that the scope of the invention be defined by the claims appended hereto.

What is claimed is:

1. A device for gathering air samples comprising:
at least one air intake tube containing a vacuum connection at one end and a distally end mounted regulating nozzle shaped to direct incoming air towards the internal surfaces of,
a capture vessel containing a well reservoir for the deposition of airborne particulates detachably affixed over the distal end of each said intake tube for open communication with ambient air, and
means for introducing air at a negative pressure through said vacuum connection and performing analysis of the particulate residue present within the well reservoir of said capture vessel.

2. The device of claim 1 further comprising:
means for detecting airborne particulates present within any of the well reservoirs of said capture vessel.

3. The device of claim 1 further comprising:
collector media housed within any of the well reservoirs of said capture vessel.

4. The device of claim 1 further comprising:
a filter placed on top or inside of the air inlet passageway of any of the well reservoirs of said capture vessel.

5. The device of claim 1 further comprising:
means for adjusting, in at least one direction, the distance separating said regulating nozzle from said well reservoir in order to optimize the deposition surface area for impaction of airborne particulates upon the interior surfaces of said capture vessel.

6. The device of claim 1 wherein:
said nozzle head shape and opening are both selected so as to regulate the speed of the incoming air flow and optimize impaction of particulates, upon the interior surfaces of said well reservoir.

7. The device of claim 1 further comprising:
a pneumatically sealed manifold plenum attached to any of said intake tube vacuum connections for distribution of said negative air pressure.

8. The device of claim 7 further comprising:
a valve that separately connects to the vacuum end of each intake tube attached to said manifold.

9. The device of claim 8 further comprising:
a circuit board and/or computer program for sequencing the sample duration and interval times of said valves.

10. The device of claim 1 wherein:
said means for introducing air at a negative pressure is a vacuum pump or blower which may be a variable speed type.

11. The device of claim 3 further comprising:
inclusion of a nucleic acid specific dye into said collector media for sensing the presence of certain airborne particulates.

12. The device of claim 3 further comprising:
inclusion of a fluorescent or radioactive nucleic acid specific probe into said collector media for sensing the presence of certain airborne particulates.

13. The device of claim 1 further comprising:
attachment of an excitation light source with photo-detector, radiation detector and/or fluorometer for focusing on the internal surfaces of a semi-translucent said well reservoir.

14. The device of claim 12 further comprising:
attachment of an excitation light source with photo-detector, radiation detector and/or fluorometer for focusing on the internal surfaces of a semi-translucent said well reservoir.

15. A method of sampling air which comprises the steps of:
attaching a vacuum connection to one end of at least one intake tube having a distally end mounted regulating nozzle shaped to direct incoming air towards the internal surfaces of a capture vessel,
affixing a well reservoir contained within said capture vessel over the distal end of each said intake tube,
maintaining a separation between said well reservoir and said regulating nozzle for open communication with ambient air,
introducing air at a negative pressure through said vacuum connection,
detaching said capture vessel from the regulating nozzle end of each said intake tube, and
performing an analysis of the airborne particulates deposited within the well reservoir of said capture vessel.

16. The method of claim 15 further comprising:
adjusting, in at least one direction, the distance separating said regulating nozzle from said well reservoir in order to optimize the deposition surface area for impaction of airborne particulates upon the interior surfaces of said capture vessel.

17. The method of claim 15 further comprising:
selecting said nozzle head shape and opening so as to regulate the speed of the incoming air flow and optimize impaction of particulates upon the interior surfaces of said well reservoir.

18. The method of claim 15 further comprising:
inserting a valve that separately connects to the vacuum end of each said intake tube.

19. The method of claim 15 further comprising:
controlling said introduced air using a circuit board and/or computer program for sequencing sample duration and interval times through valves attached at each said vacuum connection.

20. The method of claim 15 further comprising:
securing collector media within any of the well reservoirs of said capture vessel.

21. The method of claim 20 further comprising:
including a nucleic acid specific dye into said collector media for sensing the presence of certain airborne particulates.

22. The method of claim 20 further comprising:
including a fluorescent or radioactive nucleic acid specific probe into said collector media for sensing the presence of certain airborne particulates.

23. The method of claim 15 further comprising:
attaching an excitation light source with photo-detector, radiation detector and/or fluorometer for focusing on the internal surfaces of a semi-translucent said well reservoir.

24. The method of claim 22 further comprising:
attaching an excitation light source with photo-detector, radiation detector and/or fluorometer for focusing on the internal surfaces of a semi-translucent said well reservoir.

25. The method of claim 15 further comprising:
placing a filter on top or inside of the air inlet passageway of any of the well reservoirs of said capture vessel.
